(19) United States
(12) Patent Application Publication
(10) Pub. No.: US 2024/0404393 A1
(43) Pub. Date: Dec. 5, 2024

(54) CUSTOMER SECURITY STATUS AWAY SELECTIONS

(71) Applicant: Jessica Latrice Patterson, Southgate, MI (US)

(72) Inventor: Jessica Latrice Patterson, Southgate, MI (US)

(73) Assignee: Jessica Latrice Patterson, Southgate, MI (US)

(21) Appl. No.: 18/149,108

(22) Filed: Jan. 1, 2023

(51) Int. Cl. G08B 25/00; G08B 13/00; G08B 21/18

(52) U.S. Cl. CPC G08B 25/008; G08B 13/00; G08B 21/182

(57) ABSTRACT

Methods and system statuses are disclosed for identifying false alarms and indicating the level of security monitoring company and emergency response needed when the primary end-user is away. Aspects include bypassing sensor data, and ranking sensor data based on where the sensor is located at the home.

### TECHNICAL FIELD

Some implementations relate generally to remote residential surveillance, and more particularly, to communicating various away statuses to remote residential surveillance monitoring companies.

### BACKGROUND

Home surveillance systems are increasingly prevalent and allow end-users to control and input status information for those devices. Systems and methods are detailed hereinto provide users flexibility and convenience with respect to controlling status information when away from the home.

### SUMMARY

Some implementations can include a method useful for reducing false alarm events that trigger a security or emergency service response. The disclosed methods and systems give end-users the ability to indicate the level of response needed if there is a triggering event. Some alarm events would warrant monitoring company response, some would warrant emergency personnel response, others would warrant no response at all.

Away Pet Home is an option that will allow end-user with pet(s) to select when leaving pet(s) alone in the house instead of choosing the Home/Stay selection. This will allow the end-user to have to correct standard of security rather than a security company believing they or someone is still in the home. “Away/Pet Home” will activate sensors and/or cameras within the perimeter of the home to anticipate movement from a pet, but the security company will be notified that the end-user (homeowner) is no longer present in the home. With this proper level of security if there is an external breach of home the security company can better determine what assistance is needed by contacting the end-user (homeowner).

Away Elderly Home this option allows the end-user to select if an Elderly is still roaming at the home so that sensor and/or cameras will anticipate movement. With this level of security if there is a breach externally such as a broken window etc. the security company would notify the end-user stating the cameras has caught something or someone trying to enter the home or relay a message stating that an external sensor that was activated for the end-user to determine if assistance is needed. If the end-user is unable to reach the Elderly person within the home, it would be possible to check the security camera via phone. If emergency personnel is needed the security company would be notified by selecting a panic button via phone or by the elderly that is under stress.

Away Children Home this is an option for an end-user who may have children on site, the security company will be informed that children are home, but the end-user(s) are not. This additional layer of security that also comes with that if the end-user is a child that has input their own personal security code on the keypad to deactivate the current alarm status away, the code would have the capability to inform the end-user that the child is home and the security company that a child is home but the end-users are away. This also applies if the end-user's hired a third party to watch the children until a end-users have arrived home. The internal sensors and camera will anticipate movement within the home. If there is an external breach of the home the security company would notify the end-users who then confirm to send the proper authority to ensure the safety of the children.

Away Guest Home is an options is for the end-user who occasionally has visitors for shot periods of time, but at times will step out while the visitor is still in the home. Form most end-user that are living by themselves, would indeed have the habit of select away when leaving the house which would active the sensors and camera not to anticipate movement internally to the home. The end-user would potentially receive a call from the security company who believes there is a breach within the home, which would be a false alarm. This status would allow the guest to roam freely without false alarms.

### BRIEF DESCRIPTION OF THE DRAWINGS

FIG. 1 is a diagram of an example flowchart in accordance with the disclosure.

FIG. 2 is a flowchart of an example method of “Away Pets Home” in accordance with some implementations.

FIG. 3 is a flowchart of an example method of “Away Elderly Home” in accordance with some implementations.

FIG. 4 is a flowchart of an example method of “Away Children Home” in accordance with some implementations.

FIG. 5 is a flowchart of an example method of “Away Guest Home” in accordance with some implementations.

### DETAILED DESCRIPTION

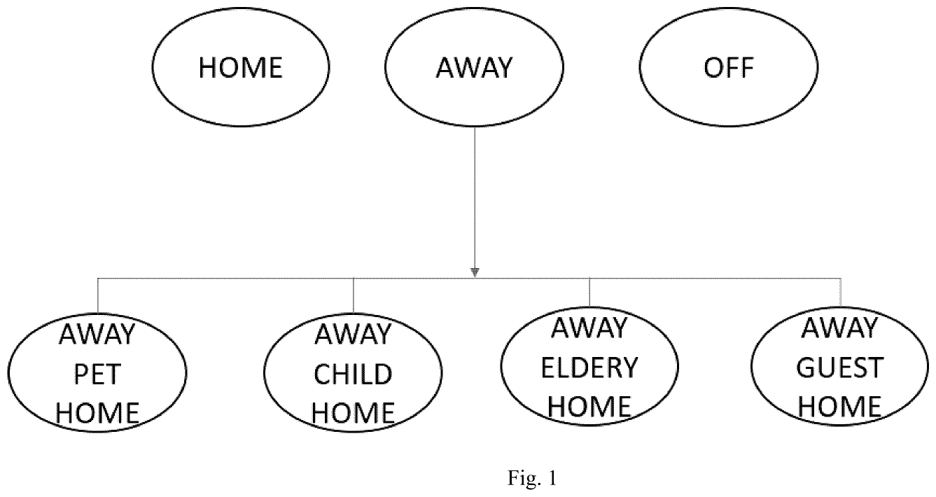

FIG. 1 is an example of an updated residential surveillance system selection screen. Once a person has selected “Away” the additional methods of away would populate the screen to determine the proper level of security that is needed.

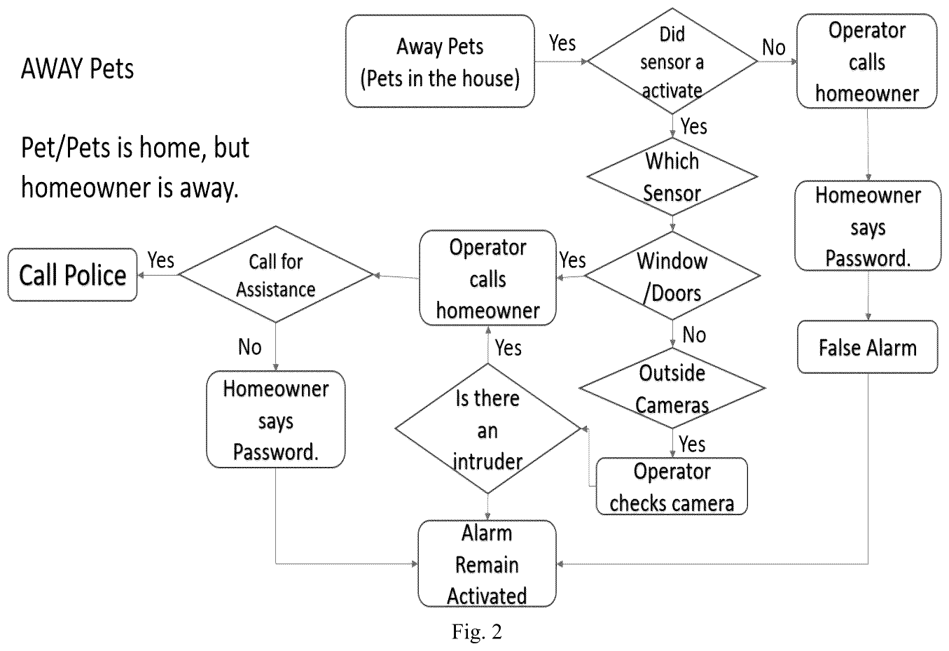

FIG. 2 is a flowchart that describes a process flow for “Away Pet Home” when there is a breach of security what is the additional steps to determine if breach is a false alarm or if help is needed such as the police, ambulance or fire department.

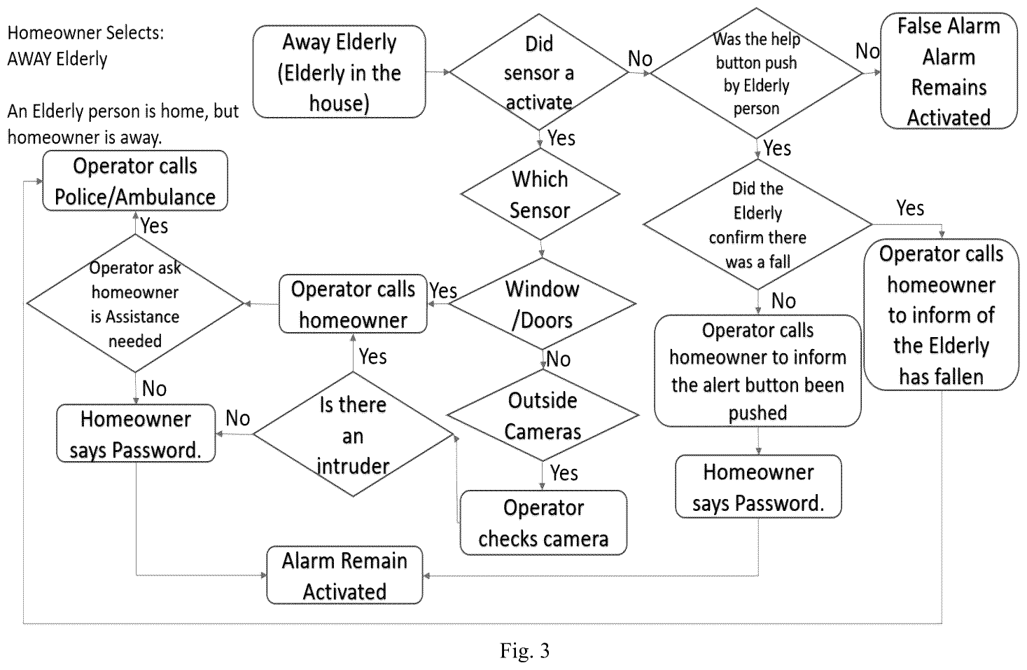

FIG. 3 is a flowchart that describes a process flow for “Away Elder Home” when there is a breach of security what is the additional steps to determine if breach is a false alarm or if help is needed such as the police, ambulance or fire department.

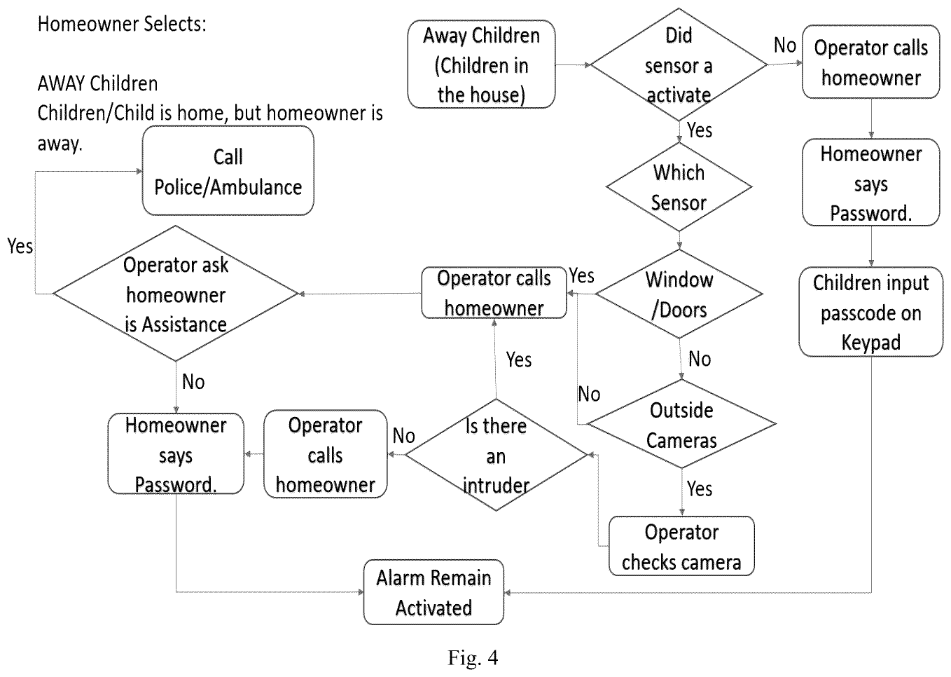

FIG. 4 is a flowchart that describes a process flow for “Away Children Home” when there is a breach of security what is the additional steps to determine if breach is a false alarm or if help is needed such as the police, ambulance or fire department.

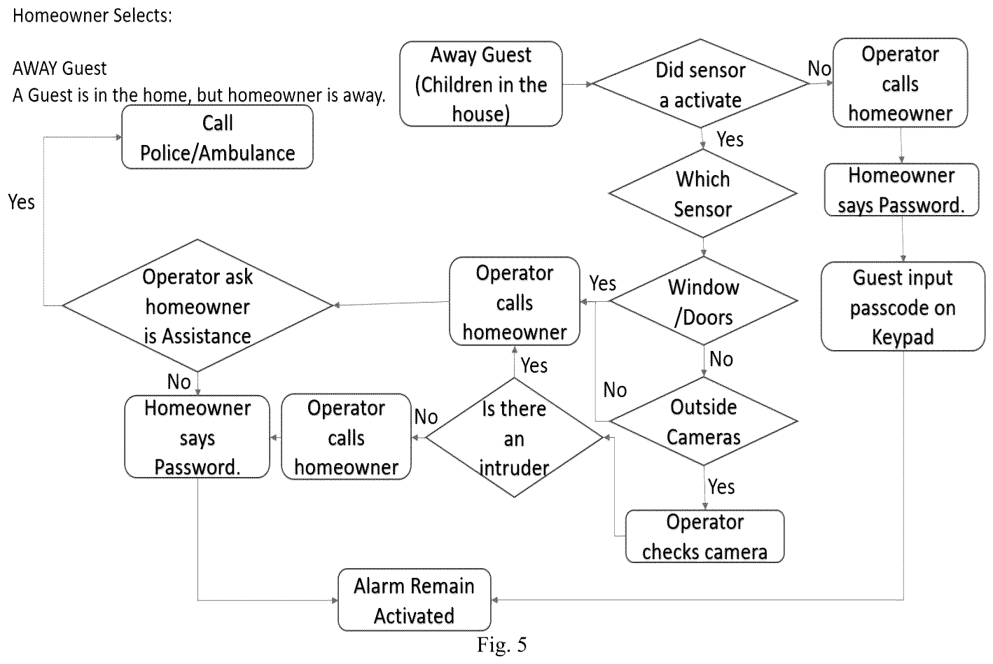

FIG. 5 is a flowchart that describes a process flow for “Away Guest Home”

What is claimed is:

1. A method comprising:
A bypass of internal home surveillance sensors indicating a security breach. A transmission of internal sensor data that does not trigger a security response unless perimeter sensors are first breached.

2. A method of nuanced “away” statuses, the method comprising:
Distinct statuses that alert the residential monitoring company of the level of response needed when internal sensors are triggered.
